(19) United States
(12) Patent Application Publication
(10) Pub. No.: US 2012/0084124 A1
(43) Pub. Date: Apr. 5, 2012

(54) SOCIAL ADVERTISING

(76) Inventor: Davi Reis, Belo Horizonte/MG (BR)

(21) Appl. No.: 13/250,198

(22) Filed: Sep. 30, 2011

Related U.S. Application Data
(60) Provisional application No. 61/388,267, filed on Sep. 30, 2010.
(60) Provisional application No. 61/388,277, filed on Sep. 30, 2010.

(51) Int. Cl. G06Q 30/02

(52) U.S. Cl. 705/14.4

(57) ABSTRACT

In general, one aspect of the subject matter disclosed in this specification can be embodied in a method for inviting a plurality of candidate badge holders to become badge holders. Criteria are defined for being a badge holder. Information is provided, to a verification system, for verifying that badge holders are authorized, the information comprising the criteria. An indication is received of issuance of a badge to a badge holder from the verification system. One or more reports are received related to activities of badge holders from a publication system that exposes badges associated with the badge holders.

### CROSS REFERENCE TO RELATED APPLICATIONS

This patent application claims the benefit of priority of U.S. Provisional Patent Application No. 61/388,267, filed Sep. 30, 2010 and U.S. Provisional Patent Application No. 61/388,277, filed Sep. 30, 2010. The content of both U.S. Provisional Patent Application No. 61/388,267 and U.S. Provisional Patent Application No. 61/388,277 is hereby incorporated by reference into this application as if set forth herein in full.

### TECHNICAL FIELD

This document relates to information presentation.

### BACKGROUND

Consumers may purchase goods and services from a merchant for a variety of reasons beyond the basic need for a particular good or service. Consumers may also choose to participate in activities associated with one or more sponsors for similar reasons. For example, a consumer might choose to purchase products from a sponsor (e.g., a retailer) because that sponsor has a reputation for supporting a particular charity.

Both consumers and sponsors can benefit from the consumer's support (e.g., public or visible support) of the sponsor. Consumer support may act as a form of advertising, and the sponsor may gain notoriety and popularity as a result. In some examples, the consumer may benefit from his association with the sponsor in that the sponsor may offer incentives to the consumer in return for the consumer's part in increasing the notoriety of the sponsor.

### SUMMARY

In general, one aspect of the subject matter disclosed in this specification can be embodied in a method for inviting a plurality of candidate badge holders to become badge holders. Criteria are defined for being a badge holder. Information is provided, to a verification system, for verifying that badge holders are authorized, the information comprising the criteria. An indication is received of issuance of a badge to a badge holder from the verification system. One or more reports are received related to activities of badge holders from a publication system that exposes badges associated with the badge holders.

In general, another aspect of the subject matter disclosed in this specification can be embodied in means for inviting a plurality of candidate badge holders to become badge holders. The aspect further includes means for defining criteria for being a badge holder. The aspect further includes means for providing, to a verification system, information for verifying that badge holders are authorized, the information comprising the criteria. The aspect further includes means for receiving an indication of issuance of a badge to a badge holder from the verification system. The aspect further includes means for receiving one or more reports related to activities of badge holders from a publication system that exposes badges associated with the badge holders.

In general, another aspect of the subject matter disclosed in this specification can be embodied in a computer storage medium encoded with a computer program, the program comprising instructions that when executed by one or more computers cause the one or more computers to perform operations comprising: inviting a plurality of candidate badge holders to become badge holders; defining criteria for being a badge holder; providing, to a verification system, information for verifying that badge holders are authorized, the information comprising the criteria; receiving an indication of issuance of a badge to a badge holder from the verification system; and receiving one or more reports related to activities of badge holders from a publication system that exposes badges associated with the badge holders.

Aspects may include one or more of the following features. Inviting a plurality of candidate badge holders comprises distributing an offer to the plurality of candidate badge holders. The offer comprises information for allowing the candidate badge holders to be verified by the verification system. The information comprises a badge identifier. The badge identifier is issued by the verification system. Inviting a plurality of candidate badge holders comprises screening candidate badge holders and inviting only candidate badge holders that pass the screening. Defining criteria comprises defining location criteria for eligible badge holders. Defining criteria comprises defining characteristics for eligible badge holders. The characteristics comprise demographic characteristics. The criteria define a level of interaction with a sponsor of the badge.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for distributing and presenting badges.

FIGS. 2A and 2B are flow diagrams of an example processes for using badges.

FIG. 3 is a diagram of an example user interface that includes badges.

FIG. 4 is a diagram of an example user interface that includes badges.

FIG. 5 is a diagram of an example badge that includes an overlay.

FIG. 6 is a diagram of example computing devices.

Like reference numbers and designations in the various drawings indicate like elements.

### DETAILED DESCRIPTION

In general, this disclosure relates to offering a designator (herein referred to as a “badge” or in the plural as “badges”) to candidates (e.g., candidate badge holders), verifying that the candidates are authorized to be issued a badge, issuing the badge to the candidates badge holders, and using the badges and related information in a presentation environment (such as to enhance the relationship between a sponsor and the badge holder).

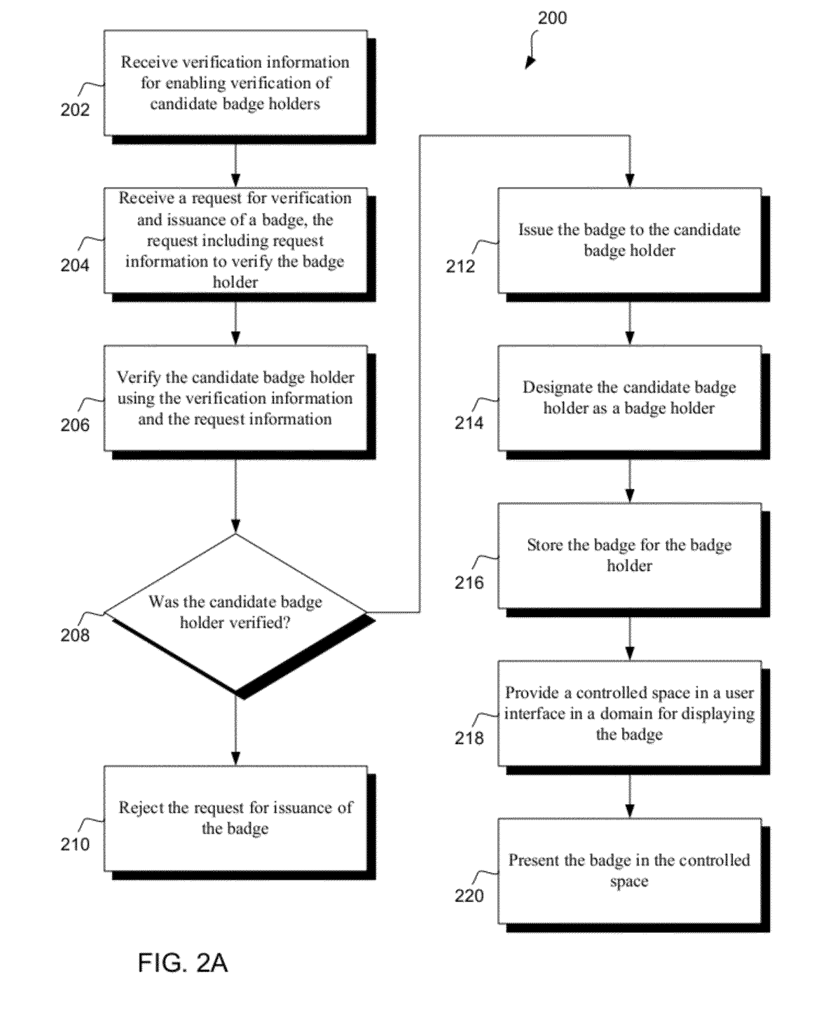

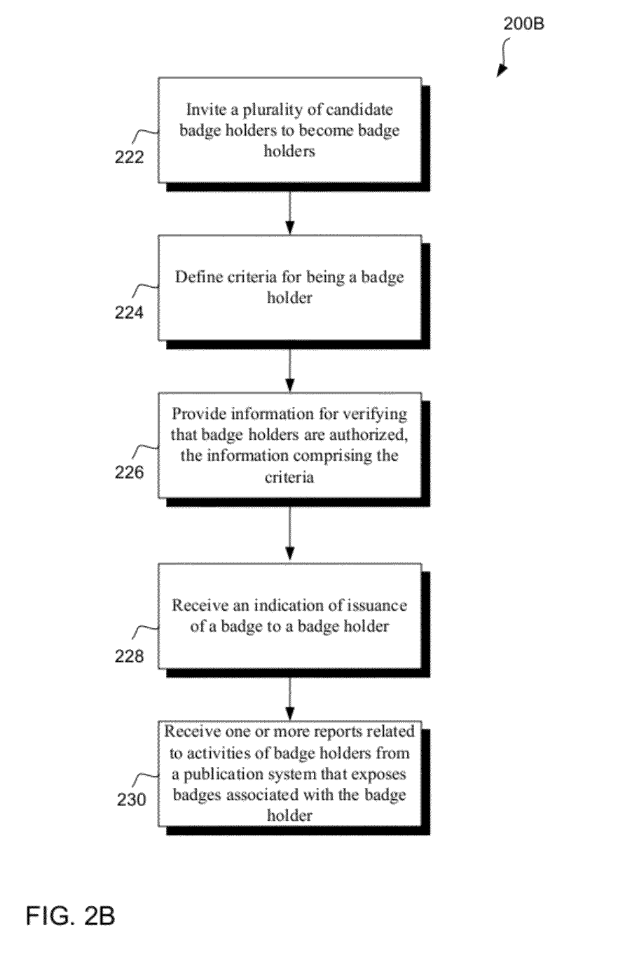

Badges, in general, are items of electronic content that are associated with one or more sponsors 102. As described in greater detail below (e.g., with regard to FIG. 2), after a candidate user 108 is issued a badge, that candidate badge holder 108 becomes a badge holder 106 with respect to the sponsor associated with the issued badge, and may collect and display the badges in a variety of venues. For example, a badge may be an icon (e.g., a graphical design) that can be displayed in a controlled space on a web page associated with the badge holder (e.g., a personal profile on a social networking site). The badge may include information about the sponsor 102, information about the reason the badge was awarded, advertising information, and/or information that instructs other users how they may obtain their own badges.

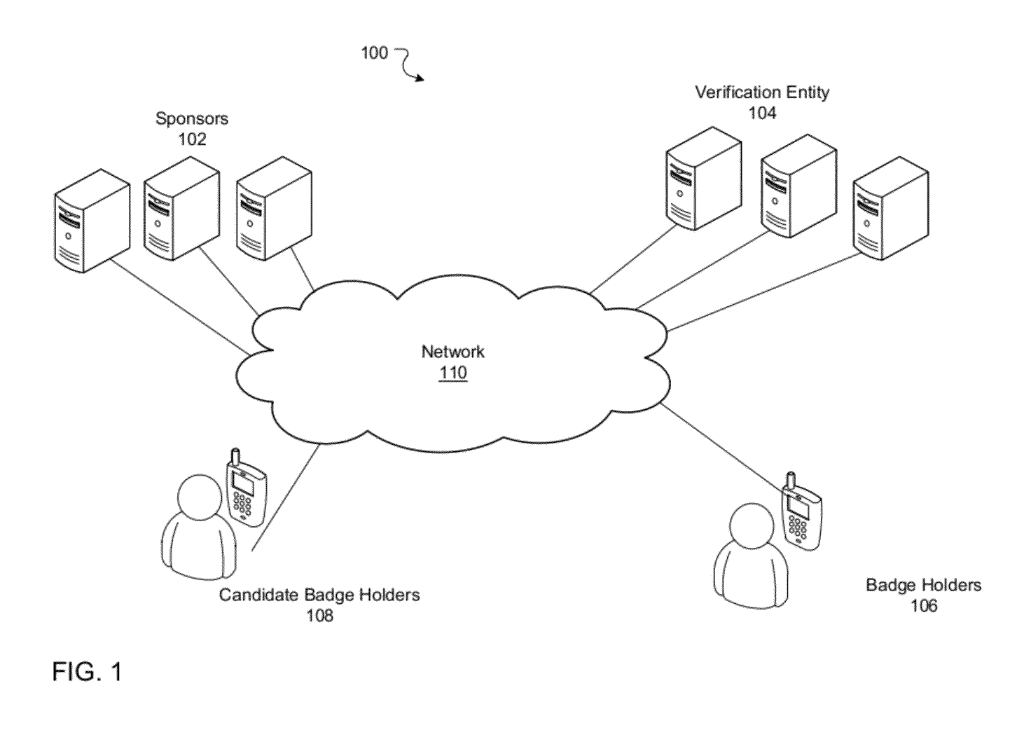

FIG. 1 shows an example system 100 for issuing and presenting badges and includes sponsors 102, a verification entity 104, candidate badge holders 108, and badge holders 106. The system 100 also includes a network 110, which can be the Internet, a local area network (LAN), a wide area network (WAN), or another type of communication network. As will be described in further detail below, while the sponsors 102, the verification entity 104, the candidate badge holders 108, and the badge holders 106 are shown as communicating through the network 110, various components of the system 100 may communicate with one or more other components of the network without the use of a network. For example, the candidate badge holder 108 may communicate directly with one or more of the sponsors 102.

In some implementations, the candidate badge holders 108 are consumers who have an interest in the goods or services offered by (or associated with) the sponsors 102. The sponsors 102, in general, provide goods, services, and/or provide some other function that is of interest to the candidate badge holders 108. For example, the sponsor 102 could be a grocery store that engages in environmentally-friendly practices while conducting its business (e.g., the sponsor 102 sells its products in “green” environmentally-friendly packaging, has low emissions, recycles plastic bags, etc). An example candidate badge holder 108 could be a customer of the sponsor 102 (e.g., someone who purchases groceries at the eco-friendly grocery store). In these examples, the candidate badge holders 108 could interact with the sponsors 102 via the network 110 (e.g., by purchasing groceries from the sponsor's 102 web page online), or may interact with the sponsors 102 directly (e.g., by physically shopping at the grocery store).

The verification entity 104 can be part of the sponsors 102, or can be a separate component of the system 100. In some implementations, the verification entity 104 can receive (e.g., over the network 110) information from either or both of the sponsors 102 and the candidate badge holders 108 in order to determine whether to issue one or more badges to the candidate badge holder 108. Once a badge has been issued to a candidate badge holder 108, the candidate badge holder 108 may gain the status of a badge holder 106.

FIG. 2A illustrates an example process 200A for issuing badges to a candidate badge holder 108, and for facilitating the presentation of issued badges. While in some examples, the verification entity 104 may perform the process 200, the process 200 may also be executed by various combinations of the sponsors 102, the verification entity 104, the badge holders 106, the candidate badge holders 108, and other entities.

Verification information is received for enabling verification of candidate badge holders (202). In some examples, the verification entity 104 receives the verification information from the sponsor 102. The receipt of verification information may follow an offer to become a badge holder made from the sponsor 102 to the candidate badge holder 108. For example, if the candidate badge holder 108 purchases groceries from the sponsor 102 (e.g. an environmentally friendly grocery store), the sponsor 102 may offer the candidate badge holder 108 the opportunity to be issued a badge and become a badge holder 106. If the candidate badge holder 108 accepts the sponsor's 102 offer, the candidate badge holder 108 may provide identifying information to the sponsor 102 that is associated with the candidate badge holder 108. For example, the candidate badge holder may provide his name, physical address, email address, telephone number, gender, age, and/or other identifying information that describes the candidate badge holder 108.

When the verification information is received (e.g., by the verification entity 104 from the sponsor 102), the verification information may include some or all of the identifying information, such as the email address of the candidate badge holder 108. The verification information may also include information about the interaction between the candidate badge holder 108 and the sponsor 102. For example, the information about the interaction may include details of a financial transaction (e.g., a purchase) between the sponsor 102 and the candidate badge holder 108, and may include the quantity of products purchased by the candidate badge holder 108, the total dollar amount of the transaction, and other details.

The verification information may also include badge identifiers for badges that have been offered to candidate badge holders 108. In general, badge identifiers identify the particular badge offered to the badge holder 108. For example, the badge identifiers may include a bar code associated with a product purchased by the candidate badge holder 108 from the sponsor 102. If the candidate badge holder 108 purchases a product in a store associated with the sponsor 102, a bar code of the product can be scanned to obtain the badge identifier. In some examples, the badge identifiers may include serial numbers for available badges that have been authorized to be issued by the sponsor 102. The serial numbers can be compared (e.g., by the verification entity 104) to determine whether the badge offered by the sponsor 102 is a badge which is authorized to be issued.

A request for verification and issuance of a badge is received, where the request includes request information to verify the candidate badge holder (204). For example, the verification entity 104 may receive the request that includes the request information after having previously received the verification information from the sponsor 102. The request information may include information for identifying the candidate badge holder 108. For example, the verification entity 104 may send an email to the email address provided by the candidate badge holder 108 to inform the candidate badge holder 108 of his potential opportunity to be issued a badge from the sponsor 102. In replying to the email (e.g., by completing a form associated with the email or visiting a web site associated with the email), the candidate badge holder 108 may provide request information that identifies the candidate badge holder in a domain associated with a verification system that issues badges. The request information may also include information for verifying that the candidate badge holder's conduct warrants issuance of a badge. For example, the request information may identify whether the potential badge holder 108 has made a sufficient contribution (e.g., a purchase or a donation) to the sponsor 102. The request information may also identify whether the candidate badge holder 108 has had sufficient contact with the sponsor 102 (e.g., the number of times that the candidate badge holder 108 has shopped at an establishment associated with the sponsor 102).

The candidate badge holder is verified using the verification information and the request information (206). For example, the verification entity 104 may determine whether to issue a badge to the candidate badge holder 108 by comparing the verification information and the request information. In some examples, the verification information may include verification criteria that may be compared to the request information. The request information may be evaluated by the verification entity to determine whether the candidate badge holder 108 meets the verification criteria prior to issuing a badge to the candidate badge holder 108. In some implementations, the verification criteria may include location criteria for requiring badge holders to be associated with a particular geographic area. For example, the location criteria may require that any badge holders must live within a certain distance from an establishment associated with the sponsor 102. Similarly, in some implementations, the verification criteria may include demographic criteria for requiring badge holders to meet certain demographic requirements. For example, the demographic criteria may dictate that badges may only be issued to candidate badge holders whose age falls within a predetermined range.

In some implementations, the verification criteria may also include membership criteria for requiring badge holders to meet certain membership requirements. For example, the membership criteria may dictate that a candidate badge holder 108 must already be a member of a “frequent shopper” program associated with the sponsor 102 in order to be issued a badge. Similarly, the membership criteria could also require that a candidate badge holder 108 already be a member of a particular organization (e.g., an environmental charity) to be eligible for a badge.

In some examples, verifying the candidate badge holder includes verifying that a candidate badge holder has been authorized to receive a badge. For example, the verification entity 104 might perform an additional check with the sponsor 102 to determine whether the candidate badge holder 108 is authorized to receive a badge. The verification entity 104 may also compare the candidate badge holder 108 against a list of unauthorized users before issuing the badge. The list of unauthorized users could include the identities of users who have been previously reported for abuse of one or more policies that may be contrary to the interests of the sponsor 102. In verifying the candidate badge holder, other badges of the candidate badge holder may be compared against a list of incompatible badges. For example, if a candidate badge holder 108 has previously been issued a badge for “supporting pollution,” an environmentally-conscious sponsor may refuse to issue an “environmentally friendly” badge to that candidate badge holder.

Verifying a candidate badge holder may also include verifying that issuance of one or more badges does not exceed a limit on a number of badges that have been authorized by a sponsor. For example, if a sponsor has authorized the release of 100 badges, the verification entity 104 might not issue a badge to a candidate badge holder after the 100 badges have been issued.

Verifying the candidate badge holder may also include verifying an identity of the candidate badge holder. For example, the verification entity may require a candidate badge holder to log into a secure website using information that is already known to the verification entity. For example, if the verification entity already has access to an email account associated with the candidate badge holder, the candidate badge holder may be required to log into that email account to verify his/her identity.

A determination is made as to whether the candidate badge holder has been verified (208). If the candidate badge holder 108 has not been verified (NO), that candidate badge holder's request for a badge is rejected (210).

If the candidate badge holder has been verified (YES), the badge is issued to the candidate badge holder (212), and the candidate badge holder is designated as a badge holder (214). For example, in issuing the badge, the verification entity 104 may enable the badge holder 106 to expose the badge in a controlled space. In some examples, a controlled space may include a portion of a web page associated with the badge holder 106 that is controlled by one or more of the verification entity 104, the sponsor 102, and/or a different entity.

After the badge is issued to the badge holder 106, the sponsor 102 associated with the badge can be notified of its issuance. This notification may allow the sponsor 102 to maintain its own badge records, which in turn may allow the sponsor 102 to offer additional badges to the badge holder 106, or to increase or decrease the number of badges that are authorized to be issued.

In some examples, issuing the badge includes identifying electronic content to associate with the badge. For example, the verification entity 104 may identify a graphical representation of a badge, such as an icon or “creative,” to associate with the badge. The identifying may include selecting a creative from a list of creatines associated with the sponsor 102, or may include searching for a suitable creative based on one or more keywords associated with the badge. For example, if the badge is issued for environmentally-friendly practices (e.g., purchasing a fuel-efficient car), the verification entity 104 (or another suitable entity) may search for badges that are associated with a “green” theme. Identifying electronic content to associate with the badge may also include allowing the badge holder 106 or the sponsor 102 to select electronic content to associate with the badge, or to upload custom electronic content. The creative may include a link to a landing page with information about the sponsor 102, or may include a control that, when activated, displays information about one or more of the issued badge and/or the sponsor 102. In some implementations, the creative may also include a logo associated with the sponsor 102.

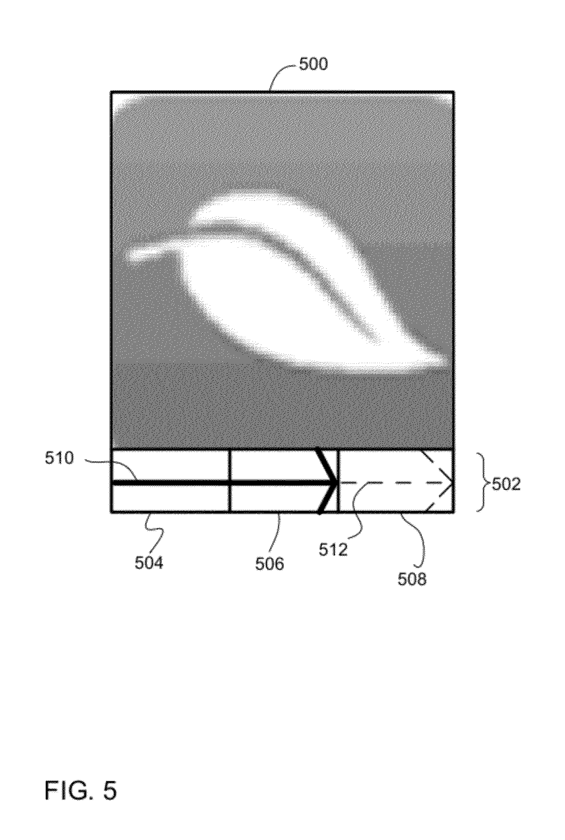

In some examples, the creative may be dynamic, and may include a presentation portion that is updated based on interaction of the badge holder 106 with the sponsor 102. For example, each time the badge holder 106 makes a purchase from the sponsor 102, the presentation portion of the awarded badge can be updated to reflect the increased level of interaction between the badge holder 106 and the sponsor 102. In some examples, a portion of the creative is not dynamic and the creative also comprises a dynamically updated portion that can be, for example, of the form of an overlay that is based on the level of interaction between the sponsor 102 and the badge holder 106. Updating the presentation portion and/or the overlay can include adjusting a progress bar, as shown in FIG. 5. The creative (e.g., a presentation portion of the creative or an overlay associated with the creative) can be updated periodically (e.g., once per month), can be updated based on a number of presentations of the creative (e.g., each time the creative is presented), or can be updated upon the request of the sponsor 102 or the badge holder 106.

The badge is stored for the badge holder (216). For example, the verification entity 104 may store an association between the issued badge and the badge holder 106 in one or more profiles associated with the badge holder 106. In some examples, storing the badge may include storing the badge along with one or more other badges that have been issued to the badge holder 106. Once stored, the badge can be enabled to be exposed in a domain associated with a storage system that stores the badge. Enabling the badge to be exposed can include changing one or more permissions to allow one or more programs to access the stored badge in order to present the badge in a controlled space.

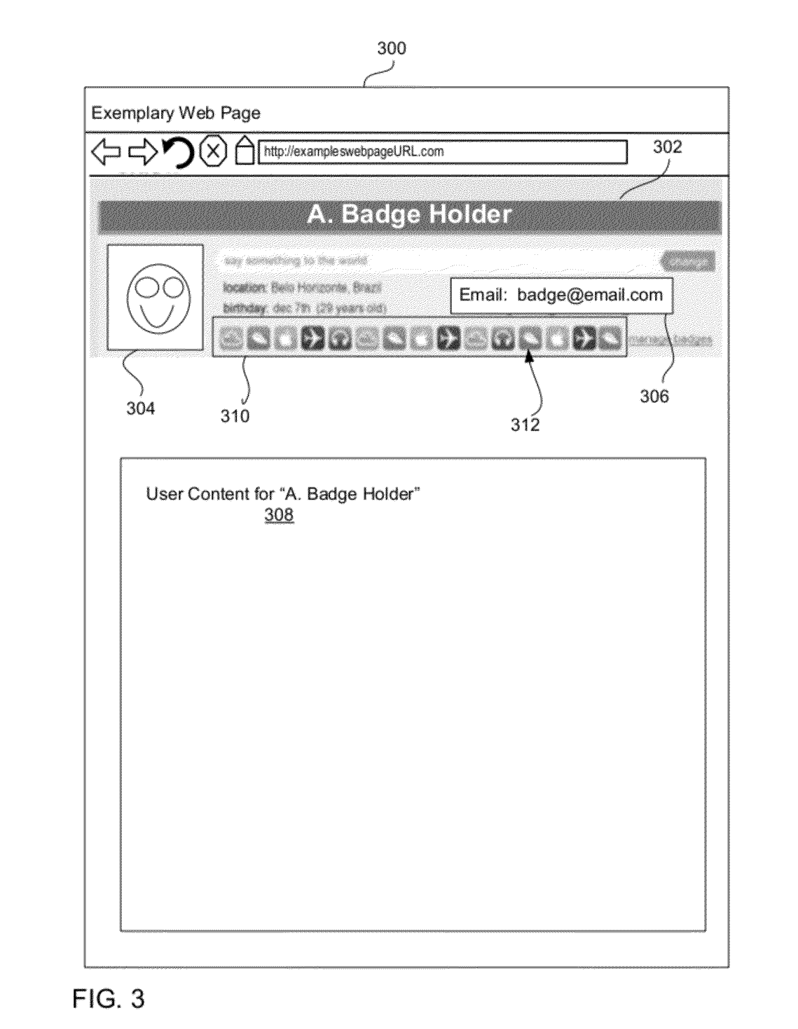

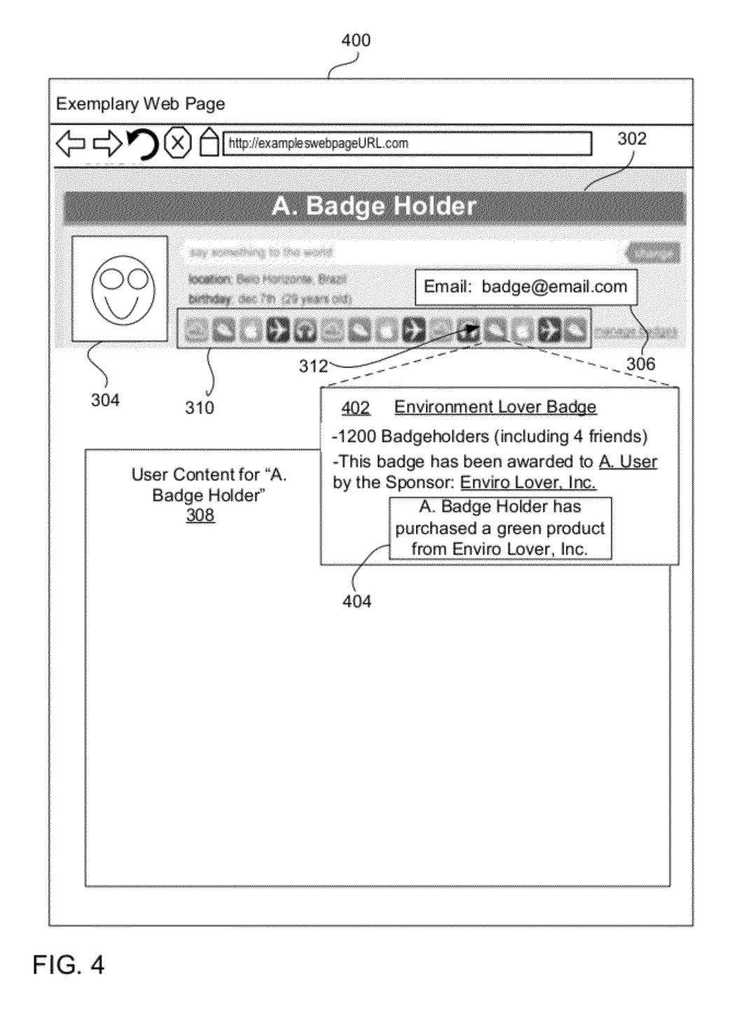

A controlled space is provided in a user interface in a domain for displaying the badge (218). In some implementations, the controlled space is a dedicated space within a domain for presenting badges. The controlled space may be a portion of a user interface that is presented in a domain that is controlled by an entity other than the badge holder 106. For examples, a portion of a badge holder's web page (e.g., a blog, or a social network profile) may be reserved for displaying badges, and the badge holder 106 may not be able to edit the content displayed in that controlled space. In some examples, the verification entity 104 and/or the sponsor 102 controls the controlled space. FIGS. 3 and 4 include examples of controlled spaces.

The badge is presented in the controlled space (220). In some implementations, the badge can be presented along with a profile for the badge holder 106. For example, badges can be presented in a controlled space on the badge holder's profile on a social networking site. Similarly, the badge can be presented on a blog (or other web site) associated with the badge holder 106. Communications from the badge holder 106 can also include a presentation of the issued badge. For example, a signature block of emails sent by the badge holder 106 can be configured to display badges that have been issued to the badge holder 106. When the badge is presented (e.g., each time the badge is presented, or every third time the badge is presented) an entity (e.g., the verification entity 104) can determine whether the badge has been revoked by a sponsor. If the badge has been revoked, presentation of the badge can be prevented, and the badge holder 106 and/or the sponsor 102 can be notified.

Sponsors 102 can be charged for operations relating to the verification and presentation of badges using a variety of fee arrangements. For example, the verification entity 102 can charge a fee that is split between the badge holder 106 and the sponsor 102 for verifying and/or issuing the badge. The fee may be charged at or after the badge has been presented a predetermined number of times (e.g., each time the badge is presented), or after a predetermined amount of time since issuance of a badge (e.g., a month after the badge has been issued to the badge holder 106). One or more entities (e.g., the verification entity 104) can track details relating to the presentation of the badge (e.g, the number of times the badge has been presented), and may report the badge exposure details to the sponsor 102. Sponsors 102 (or other entities) can use the reported information to target content to the badge holder 106, or can target content to the badge holder 106 based on information associated with one or more badges associated with the badge holder 106. The badge holders 106 can be organized into categories, and content can be targeted to a one or more of the badge holders 106 based on the categories. For example, three badge holders who all possess an “environment friendly” badge from the same sponsor 102 can be grouped into the same category and targeted with certain promotions from that sponsor 102, or sponsors that are considered to be similar in some regard.

FIG. 2B illustrates an example process 200B for offering badges to candidate badge holders. A plurality of candidate badge holders are invited to become badge holders (222). For example, the sponsor 102 may send an electronic invitation to become a badge holder 106 to a candidate badge holder 108 in the form of an email message. Similarly, if a candidate badge holder 108 is physically visiting an establishment associated with the sponsor 102, the sponsor 102 could extend an invitation to the candidate badge holder 108 (e.g., an employee of the establishment could ask the candidate badge holder 108 whether he would like to become a badge holder 106 and, after the candidate badge holder 108 provides identifying information (e.g., an email address) to the sponsor 102, an invitation can be send to the candidate badge holder). Electronic invitations sent to a candidate badge holder's email address can include a link to a web page where the candidate badge holder can confirm his identity and/or confirm his desire to receive a badge from the sponsor 102.

Criteria are defined for being a badge holder (224). In some examples, the criteria include demographic criteria. For example, the sponsor 102 may define criteria that specify that candidate badge holders must live within a certain distance from an establishment associated with the sponsor 102. Similarly, the criteria may dictate that badges may only be awarded to candidate badge holders whose age falls within a predetermined range. The criteria can also specify a required level of interaction between the sponsor 102 and the candidate badge holder 108. For example, the criteria can dictate that the candidate badge holder 108 must have purchased a certain number of goods or services from the sponsor 102 before being eligible to receive a badge and become a badge holder.

Information is provided for verifying that badge holders are authorized, the information including the criteria (226). For example, the sponsor 102 may provide information (including the criteria discuss above) to the verification entity 104 so that the verification entity may verify that the badge holders are authorized to be issued a badge. Aside from the criteria (e.g., demographic or location criteria), the information can include one or more badge identifiers. In general, badge identifiers identify the particular badge offered to the candidate badge holder 108. For example, the badge identifiers may include a bar code associated with a product purchased by the candidate badge holder 108 from the sponsor 102. If the candidate badge holder 108 purchases a product in a store associated with the sponsor 102, a bar code of the product can be scanned to obtain the badge identifier. In some implementations, the badge identifiers may include serial numbers for available badges that have been authorized to be issued by the sponsor 102. The serial numbers can be compared (e.g., by the verification entity 104) to determine whether the badge offered by the sponsor 102 is a badge which is authorized to be issued.

An indication is received of issuance of a badge to a badge holder (228). For example, the sponsor 102 can receive a communication (e.g., an email) from the verification entity 104 indicating the issuance of the requested badge to the candidate badge holder 108. The communication may include details such as a time when the candidate badge holder 108 accepted the offer to become a badge holder, and may further include information for allowing he sponsor to receive reports and track badge usage. Other information is possible.

One or more reports are received that are related to activities of badge holders from a publication system that exposes badges associated with the badge holders (230). For example, the sponsor 102 may receive reports from a publication system that is associated with the verification entity 104. The reports include details related to the badge holder's behavior, and may include a record of purchases made by the badge holder 106, as well as a number of times other users have viewed and/or accessed the badge holder's badge in a profile or communication associated with the badge holder. For example, if the badge holder exposes the sponsor's 102 badge in a user profile on a social networking web site, the social network web site may report the number of times that “friends” or “contacts” of the badge holder 106 have activated, viewed, or otherwise interacted with the badge. The reports may allow the sponsor 102 to target content (including offers to become badge holders) to other candidate badge holders. In some implementations, the reports may also include information that relates to other badges awarded to the badge holder 106, even if the badges are awarded from a sponsor that is different from the sponsor 102.

FIG. 3 is an example web page 300 that is associated with a user profile 302 for “A. Badge Holder.” The user profile 302 includes a picture 304 of the badge holder, as well as identifying information associated with the badge holder. In this example, the identifying information includes a location and birthday of the badge holder, as well as an email address 306 associated with the badge holder. The user profile 302 may also include a user content space 308 where a badge holder can provide content of his choosing (e.g., text, photo albums, or other content). In general, the user content space 308 is controllable by the badge holder.

The web page 300 also includes a controlled space 310 for displaying badges, including badge 312. As discussed above, the badge holder's control of the controlled space is at least partially limited, if not completely disallowed. The controlled space 310 may be controlled by the verification entity 104, one or more sponsors 102, one or more other entities, or a combination thereof. In this example, the badge 312 is graphically represented by a creative that resembles a leaf. The leaf, in this example, is meant to suggest that the badge 312 is somehow related to the environment. Further information about the badge 312 can be revealed, for example, if a user positions a cursor over the badge 312, or otherwise activates the badge 312. In some examples, the badges can be grouped or categorized based on one or more similar attributes of the badges.

FIG. 4 again shows the web page 300 with the badge 312 presented in the controlled space 310. In this example, the badge 312 has been activated to display further information in a detail window 402. The detail window includes information that identifies the sponsor as “Enviro Lover, Inc.,” and further identifies that the badge is an “Environment Lover Badge.” The identification of the sponsor can include a link to one or more web pages associated with the sponsor, as well as a logo of the sponsor. The detail window 402 indicates that there are 1200 badge holders that have been awarded the badge 312, including 4 “friends” of the badge holder. The “friend” information refers to the fact that 4 of the badge holder's contacts on the social networking site on which the user profile 302 appears also have been awarded the badge 312. The detail window 402 includes a narrative 404 that explains how and why the badge holder was awarded the badge 312. In this example, the badge holder was awarded the badge 312 because the badge holder purchased a “green” product from the sponsor. The detail window may also include instructions that explain how other users (such as friends of the badge holder) can also obtain the badge 312.

FIG. 5 shows an example badge 500. In this example, the badge 500 is again graphically represented by a creative that includes a graphic 501 of a leaf. The badge 500 further includes an overlay 502. The overlay 502 includes a first portion 504, a second portion 506, and a third portion 508. As described above, the overlay 502 can be presented with the badge 500 in order to provide further information related to the badge 500. The overlay 502 can be dynamically updated to provide updated and current information about interactions between the badge holder and the sponsor of the badge 500.

The overlay 502 includes a progress bar 510 that traverses the first portion 504 and the second portion 506. The progress bar in particular can graphically represent the level of interaction between the badge holder and the sponsor of the badge 500. For example, each time a badge holder purchases an eligible product from the sponsor associated with the badge 500, the progress bar 510 may advance by one portion of the overlay (e.g., from the first portion 504 to the second portion 506).

In the example of FIG. 5, the progress bar 510 includes a section 512 in the third portion 508 that represents a potential future position of the progress bar 510. The section 512 is meant to illustrate that if, for example, the badge holder reaches a next level of interaction with the sponsor of badge 500, the progress bar 510 will extend across the third portion 508 of the overlay 502. At this point, when the progress bar has “filled up” (e.g., when the progress bar 510 occupies a position represented by section 512) a predetermined action can take place. For example, when the progress bar 510 has traversed the third portion 508, the badge holder can be issued a new badge, or the current badge 500 can be altered in some way to reflect the new level of activity between the badge holder and the sponsor. In this way, badge holders and sponsors can track their interaction level, and badge holders can be rewarded for achieving certain levels of interaction.

In some examples, the presentation of badges can allow sponsors to provide enhanced services to badge holders. For example, if a user displays a badge on a user device (e.g., a cell phone) when the badge holder is completing a financial transaction (e.g., checking out after purchasing a product from a sponsor), the badge may be scanned or otherwise identified by the sponsor so that the user can receive a special discount. The badge can display an associated bar code on a mobile user device that can be scanned by a bar code scanner.

In some examples, the sponsors 102 are advertisers, and at least some their associated badges are advertisements. For example, an advertiser may issue badges using the techniques discussed above, with the badges representing advertisements for goods and/or services provided by the advertiser. The advertisements may include links to a landing page associated with the advertiser, as well as other promotional or informational features and data.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

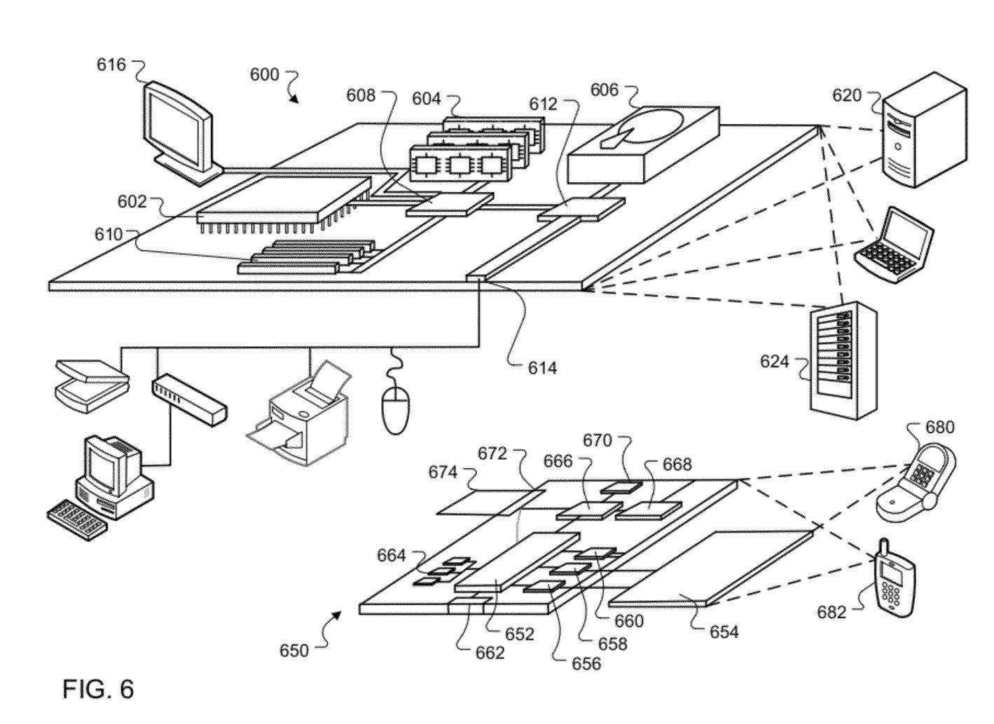

FIG. 6 shows an example of a computing device 600 and a mobile computing device 650 that can be used to implement the techniques described here. The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of computer-readable medium, such as a magnetic or optical disk.

The storage device 606 is capable of providing mass storage for the computing device 600. In some implementations, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 602), perform one or more methods, such as those described above. The instructions can also be stored by one or more storage devices such as computer- or machine-readable mediums (for example, the memory 604, the storage device 606, or memory on the processor 602).

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards (not shown). In the implementation, the low-speed interface 612 is coupled to the storage device 606 and the low-speed expansion port 614. The low-speed expansion port 614, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device (not shown), such as a mobile computing device 650. Each of such devices may contain one or more of the computing device 600 and the mobile computing device 650, and an entire system may be made up of multiple computing devices communicating with each other.

The mobile computing device 650 includes a processor 652, a memory 664, an input/output device such as a display 654, a communication interface 666, and a transceiver 668, among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a SIMM (Single In Line Memory Module) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provide as a security module for the mobile computing device 650, and may be programmed with instructions that permit secure use of the mobile computing device 650. In addition, secure applications may be provided via the SIMM cards, along with additional information, such as placing identifying information on the SIMM card in a non-packable manner.

The memory may include, for example, flash memory and/or NVRAM memory (non-volatile random access memory), as discussed below. In some implementations, instructions are stored in an information carrier. that the instructions, when executed by one or more processing devices (for example, processor 652), perform one or more methods, such as those described above. The instructions can also be stored by one or more storage devices, such as one or more computer- or machine-readable mediums (for example, the memory 664, the expansion memory 674, or memory on the processor 652). In some implementations, the instructions can be received in a propagated signal, for example, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 668 using a radio-frequency. In addition, short-range communication may occur, such as using a Bluetooth, WiFi, or other such transceiver (not shown). In addition, a GPS (Global Positioning System) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in the figure. For example, it may be implemented as a cellular telephone 680. It may also be implemented as part of a smart-phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A method performed on one or more computing devices, the method comprising:
inviting, by one or more computing devices, a plurality of candidate badge holders to become badge holders, wherein inviting comprises sending at least one electronic message to computing devices associated with each of the plurality of candidate badge holders;
defining criteria for the plurality of candidate badge holders to receive badges;
providing, to a verification system, by one or more computing devices, information for verifying that a particular candidate badge holder of the plurality of candidate badge holders is authorized to receive a badge, wherein the information relates to the criteria;
receiving, by one or more computing devices, an indication of issuance of a badge to the particular candidate badge holder from the verification system; and
receiving, by one or more computing devices, one or more reports related to activities of the particular badge holder from a publication system that exposes badges associated with the badge holder.

2. The method of claim 1, wherein inviting the plurality of candidate badge holders comprises distributing an offer to the plurality of candidate badge holders.

3. The method of claim 2, wherein the offer comprises information for allowing the plurality of candidate badge holders to be verified by the verification system.

4. The method of claim 3, wherein the information comprises a badge identifier.

5. The method of claim 4, wherein the badge identifier is issued by the verification system.

6. The method of claim 1, wherein inviting the plurality of candidate badge holders comprises screening the plurality of candidate badge holders and inviting only candidate badge holders of the plurality of candidate badge holders that pass the screening.

7. The method of claim 1, wherein defining criteria comprises defining location criteria for eligible badge holders.

8. The method of claim 1, wherein defining criteria comprises defining characteristics for eligible badge holders.

9. The method of claim 8, wherein the characteristics comprise demographic characteristics.

10. The method of claim 8, wherein the criteria define a level of interaction with a sponsor of the badge.

11. One or more computer storage devices comprising instructions that, when executed by one or more computing devices, cause the one or more computing devices to perform operations comprising:
inviting, by one or more computing devices, a plurality of candidate badge holders to become badge holders, wherein inviting comprises sending at least one electronic message to computing devices associated with each of the plurality of candidate badge holders;
defining criteria for the plurality of candidate badge holders to receive badges;
providing, to a verification system, by one or more computing devices, information for verifying that a particular candidate badge holder of the plurality of candidate badge holders is authorized to receive a badge, wherein the information relates to the criteria;
receiving, by one or more computing devices, an indication of issuance of a badge to the particular candidate badge holder from the verification system; and
receiving, by one or more computing devices, one or more reports related to activities of the particular badge holder from a publication system that exposes badges associated with the badge holder.

12. The computer storage medium of claim 11, wherein inviting the plurality of candidate badge holders comprises distributing an offer to the plurality of candidate badge holders.

13. The computer storage medium of claim 12, wherein the offer comprises information for allowing the plurality of candidate badge holders to be verified by the verification system.

14. The computer storage medium of claim 13, wherein the information comprises a badge identifier.

15. The computer storage medium of claim 14, wherein the badge identifier is issued by the verification system.

16. The computer storage medium of claim 11, wherein inviting the plurality of candidate badge holders comprises screening the plurality of candidate badge holders and inviting only candidate badge holders of the plurality of the candidate bade holders that pass the screening.

17. A system comprising:
one or more computing devices; and
one or more memory devices comprising instructions that, when executed by one or more computing devices, cause the one or more computing devices to perform operations comprising:
inviting, by one or more computing devices, a plurality of candidate badge holders to become badge holders, wherein inviting comprises sending at least one electronic message to computing devices associated with each of the plurality of candidate badge holders;
defining criteria for the plurality of candidate badge holders to receive badges;
providing, to a verification system, by one or more computing devices, information for verifying that a particular candidate badge holder of the plurality of candidate badge holders is authorized to receive a badge, wherein the information relates to the criteria;
receiving, by one or more computing devices, an indication of issuance of a badge to the particular candidate badge holder from the verification system; and
receiving, by one or more computing devices, one or more reports related to activities of the particular badge holder from a publication system that exposes badges associated with the badge holder.

18. The system of claim 17, wherein defining criteria comprises defining characteristics for eligible badge holders.

19. The system of claim 18, wherein the characteristics comprise demographic characteristics.

20. The system of claim 17, wherein the criteria define a level of interaction with a sponsor of the badge.
